(19) United States
(12) Patent Application Publication
(10) Pub. No.: US 2026/0270792 A1
(43) Pub. Date: Sep. 10, 2026

(54) METHODS FOR OPTIMIZING ANTENNA PARAMETERS IN A COMMUNICATION NETWORK SYSTEM USING A NETWORK CONTROLLER

(71) Applicant: CABLE TELEVISION LABORATORIES, INC., Louisville, CO (US)

(72) Inventors: Eric Gerard Nachtigall, Broomfield, CO (US); Randy Levensalor, Boulder, CO (US)

(21) Appl. No.: 19/562,253

(22) Filed: Mar. 10, 2026

Related U.S. Application Data
(60) Provisional application No. 63/769,564, filed on Mar. 10, 2025.

(51) Int. Cl. H04W 28/18

(52) U.S. Cl. CPC H04W 28/18

(57) ABSTRACT

Methods for optimizing antenna parameters in a communication network system using a network controller are provided. One or more antennas in a communication network system are detected by a network controller and each antenna includes one or more sensors configured to measure sensor data. A feedback loop is executed by the network controller and includes determining a radio frequency (RF) coverage based on the sensor data and optimizing the one or more antenna parameters based on protocol data and the RF coverage to yield one or more optimized antenna parameters. The feedback loop also includes applying the antenna parameters to the antennas and receiving updated network data from the sensors. The feedback loop repeats until the network controller commands the feedback loop to end.

### CROSS REFERENCE TO RELATED APPLICATIONS

This application claims the benefit of and priority to U.S. Provisional Application No. 63/769,564, filed on Mar. 10, 2025, which is incorporated herein by reference in its entirety.

### BACKGROUND

The field of the disclosure relates generally to optimizing antenna parameters, and more particularly, to optimizing antenna parameters in a communication network system using a network controller.

Hybrid fiber-coaxial (HFC) networks is a telecommunication network that combines optical fiber for long-distance transmission of data and coaxial cable for local transmission of data to end users. Such HFC networks utilize optical signals in the optical fiber and radio frequency (RF) signals in the coaxial cable to deliver data to the end users.

A distributed antenna system (DAS) is a network of antennas spaced from each other and connected to a common source. The DAS can be used to, for example, improve wireless coverage in buildings, high-density areas, and/or outdoor spaces. In some instances, a DAS can be used on the HFC network in which the DAS can be connected to the coaxial cable of the HFC network and use the HFC network as a common source.

However, use of the DAS on the HFC network presents a unique issue of self-interference via HFC leaks (i.e., egress) or paths for external RF to get into the HFC network's coaxial cables (i.e., ingress). Further, the HFC network does not typically have a way to provide spectrum coordination or management of wireless communications to prevent such interference. Thus, there is a desire in the industry to mitigate or eliminate network deficiencies, such as self-interference, in communication network systems such as an HFC network with a DAS.

### SUMMARY

Embodiments of the present disclosure leverage a network controller to optimize antenna parameters of antennas in a distributed antenna system (DAS) using a hybrid fiber-coaxial (HFC) network to prevent, reduce, or eliminate self-interference caused by use of the DAS in the HFC network. The network controller executes a feedback loop that includes determining radio frequency (RF) coverage based on sensor data received from sensors, receiving protocol data regarding protocols for data transfer in the HFC network, and optimizing the antenna parameters to prevent, reduce, or eliminate network deficiencies within constraints of the protocol data. Thus, the network controller beneficially prevents, reduces, or eliminates network deficiencies using a feedback loop to continuously optimize and improve antenna parameters based on current RF and/or network conditions and coverage, protocol data, and/or existing network deficiencies.

A method for optimizing one or more antenna parameters according to at least one embodiment of the present disclosure comprises detecting, by a network controller, one or more antennas in a communication network system, each antenna having one or more sensors configured to measure sensor data; executing, by the network controller, a feedback loop comprising: receiving the sensor data from the one or more sensors; determining a radio frequency (RF) coverage based on the sensor data; receiving protocol data from a spectral management service, the protocol data comprising one or more rules for transmitting data in the communication network system; optimizing the one or more antenna parameters based on the protocol data and the RF coverage to yield one or more optimized antenna parameters; applying the one or more optimized antenna parameters to the one or more antennas; and receiving updated network data from the one or more sensors, wherein the feedback loop repeats until the network controller commands the feedback loop to end.

Any of the aspects herein, wherein the RF coverage comprises at least one of a network coverage or a network performance.

Any of the aspects herein, further comprising: detecting a network deficiency based on the sensor data, wherein the one or more antenna parameters are further optimized to at least one of reduce or eliminate the network deficiency.

Any of the aspects herein, wherein the protocol data comprises at least one of wireless coexistence protocol data, non-wireless protocols, wireless communication protocol data, Internet of Things (IoT) protocol data, lower powered device protocol data, or over-the-air protocol data.

Any of the aspects herein, wherein the protocol data is implemented by at least one of an RF physical (PHY) layer or over a hybrid-fiber coaxial (HFC) network using RF.

Any of the aspects herein, further comprising: initializing the communication network system prior to detecting the one or more antennas.

Any of the aspects herein, further comprising: storing sensor data, by the sensors, in a database.

Any of the aspects herein, wherein the feedback loop is repeated based on at least one of a time interval or an event-based trigger.

Any of the aspects herein, wherein the event-based trigger comprises at least one of detecting the network deficiency, a scheduled trigger, a utilization trigger, or a maintenance trigger.

Any of the aspects herein, wherein the one or more antenna parameters are optimized by a feedback loop executed by a PHY coexistence management layer.

Any of the aspects herein, wherein the one or more antenna parameters comprises at least one of an antenna frequency, an antenna pattern, an antenna frequency, an antenna pattern, a gain, a bandwidth, a schedule frequency change, or an effective isotropic radiated power (EIRP) setting.

Any of the aspects herein, wherein the one or more antenna parameters are applied to a radio frequency (RF) front end of a distributed antenna system (DAS) element, and wherein the DAS element also includes a corresponding antenna of the one or more antennas.

Any of the aspects herein, wherein the communication network system comprises a hybrid fiber-coaxial (HFC) network comprising an HFC front end in communication with one or more HFC nodes, wherein each HFC node is in communication with one or more end users.

Any of the aspects herein, wherein the network data comprises at least one of a location of each antenna of the one or more antennas, a location of each HFC node of the one or more HFC nodes, and a current RF environment.

A method for optimizing one or more antenna parameters according to at least one embodiment of the present disclosure comprises detecting, by a network controller, one or more antennas in a communication network system, each antenna having one or more sensors configured to measure network data; receiving, by a network processor, the network data from the one or more sensors; determining, by the network processor, a network coverage based on the network data; detecting, by the network processor, a network deficiency based on the network data; executing, by the network controller, a feedback loop comprising: receiving the network deficiency from the network processor; receiving protocol data from a spectral management service, the protocol data comprising one or more rules for transmitting data in the communication network system; optimizing one or more antenna parameters to reduce the network deficiency based on the protocol data to yield one or more optimized antenna parameters; applying the one or more optimized antenna parameters to the one or more antennas; and receiving updated network data from the one or more sensors, wherein the feedback loop repeats until the network controller commands the feedback loop to end.

Any of the aspects herein, further comprising: storing, by the network controller, the network data in a database.

Any of the aspects herein, wherein the one or more antenna parameters are optimized by a feedback loop executed by a PHY coexistence management layer.

Any of the aspects herein, wherein the one or more antenna parameters comprises at least one of an antenna frequency, an antenna pattern, an antenna frequency, an antenna pattern, a gain, a bandwidth, a schedule frequency change, or an effective isotropic radiated power (EIRP) setting.

Any of the aspects herein, wherein the one or more antenna parameters are applied to a radio frequency (RF) front end of a distributed antenna system (DAS) element, and wherein the DAS element also includes a corresponding antenna of the one or more antennas.

A communication network system according to at least one embodiment of the present disclosure comprises one or more distributed antenna system (DAS) elements, each DAS element comprising: an antenna, each antenna having one or more sensors configured to measure network data; a radio frequency (RF) front end; and a controller configured to receive and execute one or more optimized antenna parameters; a spectral management service configured to store protocol data comprising one or more rules for transmitting data in the communication network system; a network controller in communication with the one or more DAS elements and the spectral management service, the network controller configured to execute a feedback loop comprising: receiving the network data from the one or more sensors; determining a network coverage based on the network data; receiving the protocol data from the spectral management service; optimizing one or more antenna parameters based on the protocol data and the network coverage to yield the one or more optimized antenna parameters; applying the one or more optimized antenna parameters to the RF front end of each DAS element; and receiving updated network data from the one or more sensors, wherein the feedback loop repeats until the network controller commands the feedback loop to end.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a communication network system according to at least one embodiment of the present disclosure;

FIG. 2A is a dataflow of a communication network system according to at least one embodiment of the present disclosure;

FIG. 2B is another dataflow of a communication network system according to at least one embodiment of the present disclosure;

FIG. 3A is a flowchart according to at least one embodiment of the present disclosure;

FIG. 3B is a flowchart according to at least one embodiment of the present disclosure;

FIG. 4A shows an example of a computing system, in accordance with one or more embodiments; and

FIG. 4B shows an example of a network, in accordance with one or more embodiments.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “telecommunication network” refers to a system of interconnected devices connected by links (e.g., cable, fiber, wireless, etc.) over which data can be transmitted between the interconnected devices. The telecommunication network can include, for example, cable networks, hybrid fiber-coaxial networks, fiber networks, a radio frequency network, any wired network, any wireless network, or any hybrid network.

As used herein, the term “hybrid fiber-coaxial” (HFC) network refers to a network architecture that combines fiber-optic cables for long distance transmission from an HFC headend to a regional or local HFC node and coaxial cables for local delivery from the HFC node to an end user. The HFC node converts optical signals from the fiber-optic cables to radio frequency (RF) signals for transmission over the coaxial cables.

As used herein, the term “distributed antenna system” (DAS) refers to a network of antennas that provides wireless service within an area or structure. The network of antennas is connected to a common source or hub supplying signals such as, for example, off-air signals and/or cellular signals. The DAS can be a passive system, an active system, a hybrid system (e.g., passive and active) and the DAS can be an analog, a digital, or a hybrid implementation.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

As used herein, the term “frequency” refers to a specific tone in Hertz (Hz) (e.g., 100 MHz). Frequency can be used as a reference for a frequency set or channel when used as a center, start, or stopping point designation.

As used herein, the term “frequency set” refers to a set of frequencies from A Hz to B Hz, where A<B. For example, a data over cable service interface specification (DOCSIS) orthogonal frequency-division multiplexing (OFDM) is a set of subcarrier frequencies tones at even spacing forming the entire signal.

As used herein, the term “channel” refers to a designated frequency set as defined in a physical (PHY) layer specification or in adherence to an implementation of an RF or RF modulated optical communication system. For example, DOCSIS may contain two or more channels of OFDM signals as configured in a system settings.

As used herein, the term “channel set” refers to a set of channels such as, for example, 1 to N channels, where each channel in 1 to N is a frequency set in itself (e.g., A1-B1 in Channel 1, A2-B2 in Channel 2 . . . AN-BN in Channel N). For example, DOCSIS may have several legal channel sets depending on where a channel split is located.

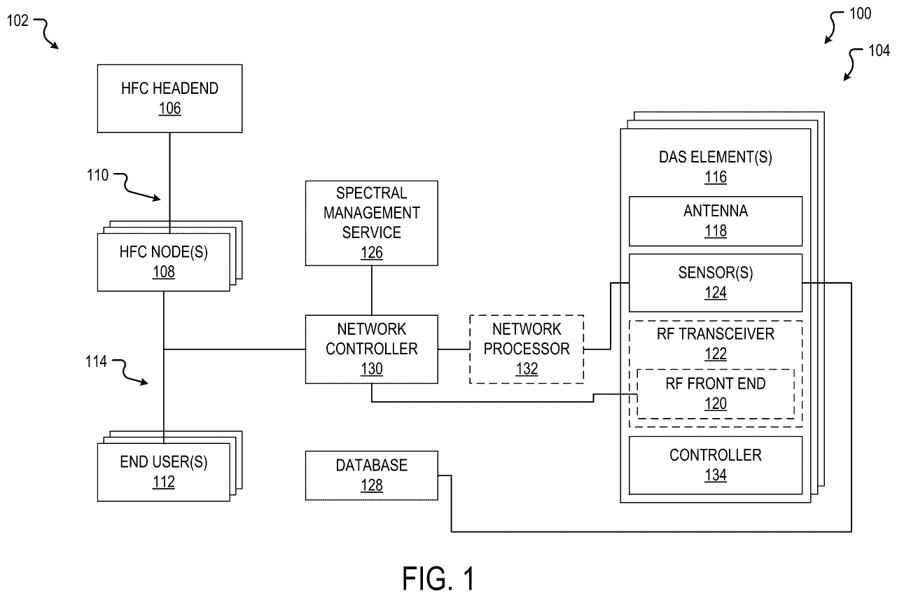

Turning to the Figures, FIG. 1 is a block diagram of a communication network system (100) (also referred to as “the system (100)”) according to at least one embodiment of the present disclosure. The system (100) is configured to optimize one or more antennas in the system (100) based on network protocols and network conditions for the purpose of reducing or eliminating network deficiencies (e.g., self-interference). For example, the system (100) may be configured to optimize parameters for an RF front end to control the wireless signal distribution performed at each antenna and to prevent, reduce, or eliminate self-interference in the system (100).

As shown, the system (100) includes a hybrid fiber-coaxial network (HFC) (102) and a distributed antenna system (DAS) (104) that uses the HFC network (102) as a common signal source. It will be appreciated that the HFC network (102) is an example network and that the system (100) can include any type of telecommunication network.

The HFC network (102) includes an HFC headend (106) connected to one or more HFC nodes (108) via fiber-optic cable(s) (110) and each HFC node (108) is connected to one or more end users (112) via coaxial cable(s) (114). The HFC network (102) can include more or less components such as, for example, amplifiers, distribution hubs, couplers, splitters, etc.

As previously described, data is transmitted from the HFC headend (106) to the HFC nodes (108) as an optical signal over the fiber-optic cable (110). The optical signals are then converted to RF signals at the HFC nodes (108) and transmitted to the end users (112) over the coaxial cables (110).

The DAS (102) includes one or more DAS elements (116) connected to the cable(s) (114). In at least one embodiment the cables (114) are coaxial cables, though in other embodiments the cables (114) can be any type of cable capable of data transmission. As shown, each DAS element (116) includes an antenna (118) for transmitting and receiving RF signals, an RF transceiver (122) configured to also transmit and receive RF signals, and an RF front end (120) (of the RF transceiver (122)) configured to process RF signals received and to control RF signals transmitted. In some embodiments, the DAS element (116) can include an RF transmitter and an RF receiver instead of the RF transceiver (122). In the illustrated embodiment, the RF transceiver (122) is shown separately from the antenna (118), though in other embodiments the RF transceiver (122) may be integrated with the antenna (118).

The DAS element (116) also includes a controller (134) configured to receive and process commands and/or to execute local configurations. In some embodiments, the controller (134) receives, for example, optimized antenna parameters from the network controller (130) and implements the optimized antenna parameters on the RF front end (120).

The DAS element (116) and each DAS element (116) component (e.g., the RF front end (120) and the RF transceiver (122)) can include more or less components such as, for example, a power source, filters, duplexers, switches, mixers, amplifiers, converters, etc. For example, in some embodiments, the DAS element (116) may not include the RF transceiver (122) and may instead include an HFC to Air RF interface.

In such embodiments, the HFC to Air RF interface is a flexible radio front end attached to a DAS element, configured to convert or change the RF signal without processing the contents of the RF signal. More specifically, the HFC to Air RF interface contains a frequency band selection and/or channel selection mechanism (e.g., filters or digital signal processors (DSPs)) for selecting an RF channel from, for example, the coaxial cable (114) at a specific set of frequencies, to be broadcast over the air at another channel (i.e., set of frequencies) in a downstream transmission mode (e.g., data moving from the network to an end user, subscriber, and/or data sink). The HFC to Air interface includes up/down conversion device and method(s) of gain control (e.g., amplification and/or attenuation).

The HFC to Air interface may also contain switches or circulators to enable time duplexing, frequency duplexing, or a superset of both operational modes and can be parallelized to handle more than one channel. The HFC to Air RF interface is also configured to receive a specific RF channel from the air and convert the over the air signal to the appropriate frequency set (i.e., channel) for the coaxial cable (114) (or other coaxial transport medium or fiber medium via RF modulation of a laser source), acting in reception for upstream transmission (e.g., data moving from a user/subscriber/source into the network) using the same process as used in the downstream transmission over the air.

As shown, the DAS element (116) also includes sensor(s) (118) configured to sense, collect, and/or measure sensor data (correlating to RF data and/or network data) such as, for example, location(s) of the antenna(s) (118), location(s) of the HFC node(s) (108), RF signal data, spectrum data, and/or a current RF environment. The sensor data can also include, for example, ingress and egress data collected at the HFC node locations, DAS elements, or other intermediate elements or sensors, protocol type and/or classification data, configuration data, scheduler data, device telemetry, etc. Such sensor data can be transmitted over one or more protocols such as, for example, DOCSIS for Cable Modem, 5G New Radio (5GNR) for DAS, etc. Though not shown, the system (100) can include other sensors positioned throughout the system (100), in addition to the sensors (124), that can be used to sense, collect, and/or measure network data.

The system (100) also includes a spectral management service (126) that stores data such as, for example, protocol data, telemetry data, RF telemetry data, etc. The telemetry data may include, for example, interference data, RF signal data, etc. The protocol data can include, among other data, one or more rules for transmitting data in the system (100). The protocol data can be, for example, wireless coexistence protocol data, wireless communication protocol data, non-wireless protocols, long range (LoRa) protocol data, Internet of Things (IoT) protocol data, lower powered device protocol data, over-the-air protocol data, physical (PHY) layer protocol data, etc. For example, the protocol data can include information such as approved licensed bands, unlicensed frequency and/or spectrum controllers, and/or information about mass wireless managed systems that are commercially available. The protocol data can also include information such as, for example, key performance indicators (KPIs) and/or key performance metrics (KPMs) of various operators, providers, and/or vendors. Such KPIs and/or KPMs can be obtained from streaming or continuous data received from the sensors (124) and/or by retrieving or polling data on demand from the operators, providers, vendors, and/or other databases such as, for example, a database (128).

The system (100) also includes the database (128). The database (128) can include one or more databases. The databases (128) may be local, distributed, or remote and may be centralized to the system (100) and/or located at the sensors (124) and/or the antenna (118). The database (128) can store, for example, sensor data from the sensors (118) and/or RF data and/or network data as processed from the sensor data. In other words, sensor data correlating to full network data and/or RF data can be stored in the databases (128) and later processed and/or analyzed.

The database (128) can also store geographical and/or time logs corresponding to the sensor data, the RF data, and/or the network data. As shown, the database (128) may be in communication with the sensors (118) to receive and store sensor data directly from the sensors (118). In other embodiments, the database (128) may be in communication with, for example, a network controller (130) and/or a network processor (132) (described below) and may receive the RF data and/or network data from the network controller (130) and/or the network processor (132).

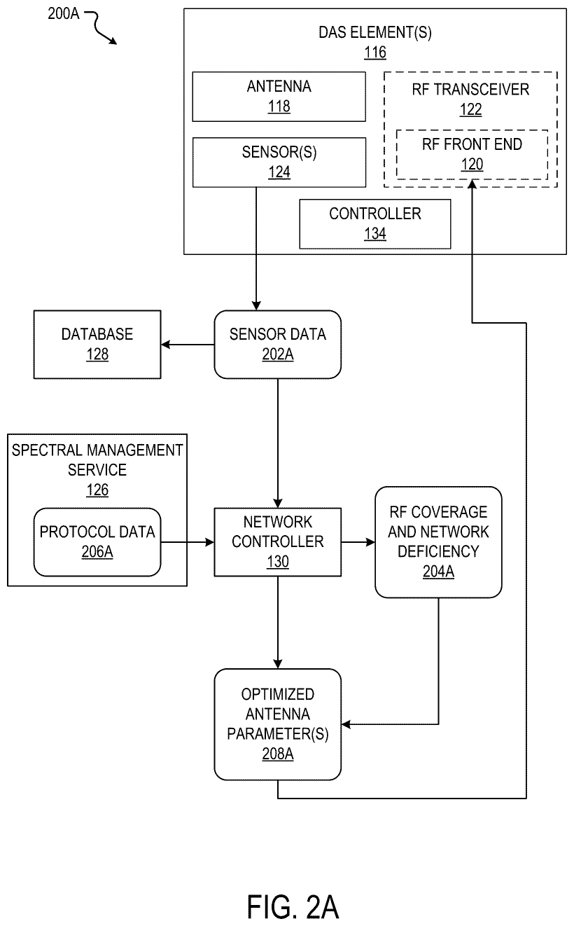

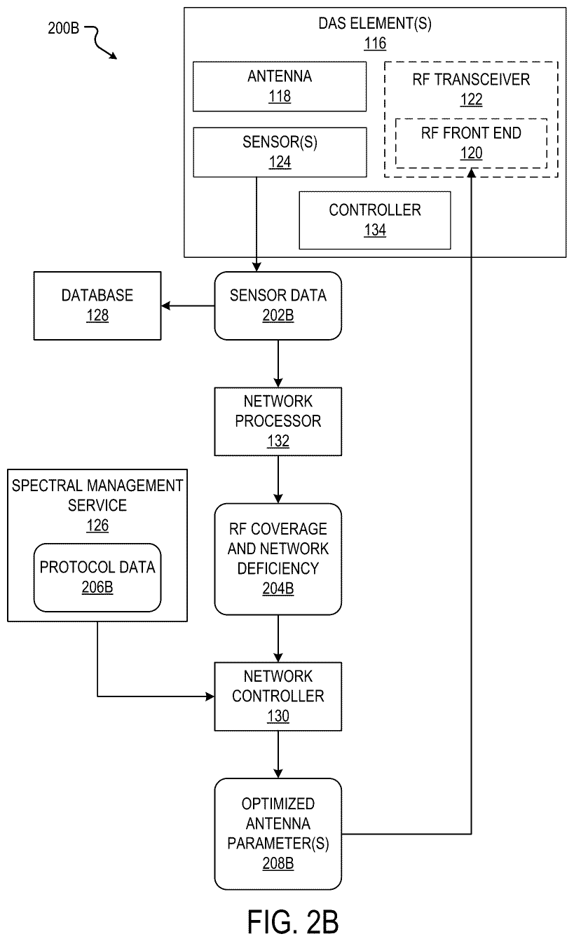

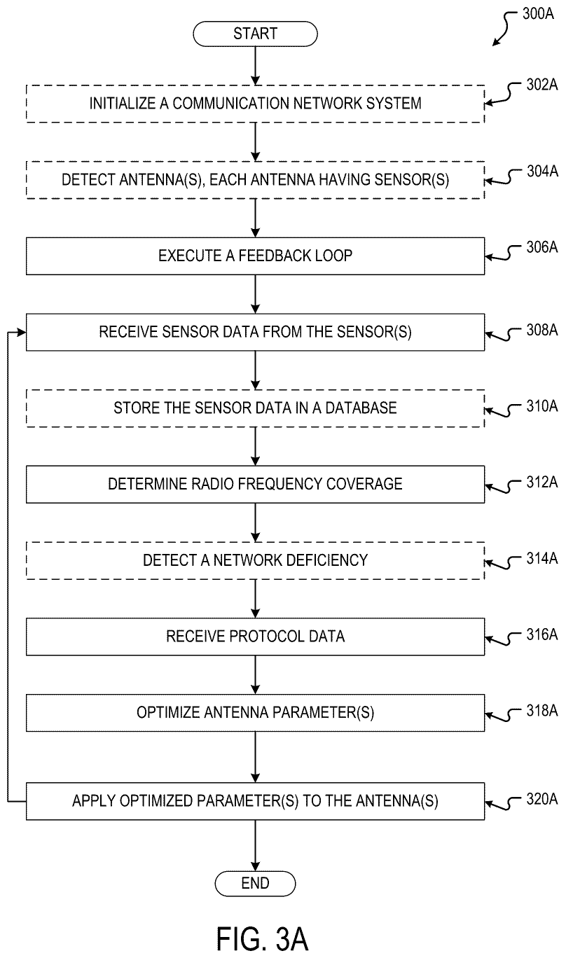

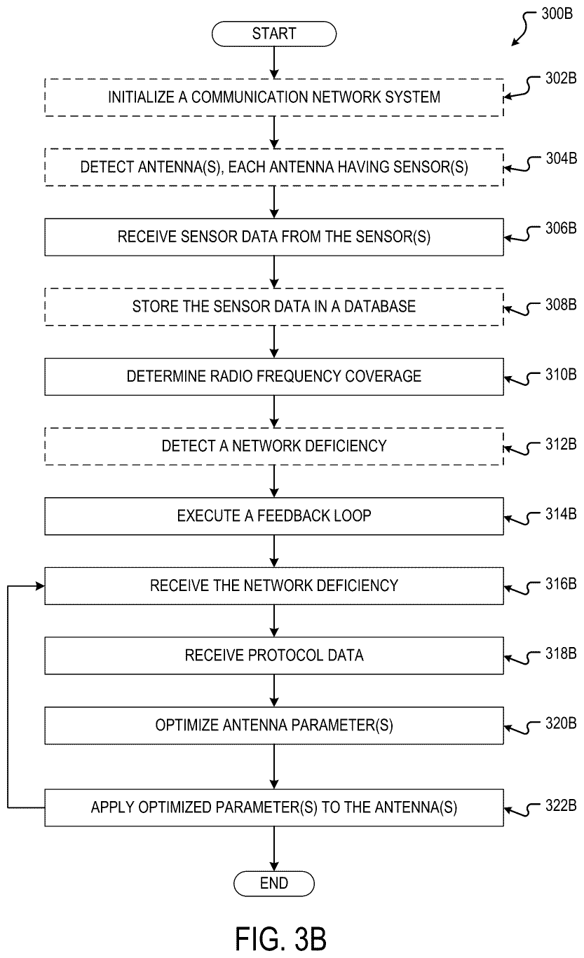

The system (100) also includes the network controller (130). The network controller (130) is configured to optimize antenna parameters of the antennas (118). More specifically, the network controller (130) optimizes antenna parameters that are applied to the RF front end (120) based on at least RF data and/or network data, whether received from the sensors (124) and stream processed in real-time and/or received from the database (128) and post processed, and protocol data received from the spectral management service (126). In other words, the network controller (130) controls and optimizes RF frequency generation and assignment at the RF front end(s) (120) of each DAS element (116) to prevent, reduce, or eliminate self-interference in the system (100) or other network deficiencies. Use of the network controller (130) to optimize antenna parameters is described in detail in FIGS. 2A, 2B, 3A, and 3B.

The network controller (130) can generate instructions to apply the antenna parameters to the RF front end (120) (via the controller (134)) and transmit such instructions via the HFC network (102) (via the coaxial cables (114)) via an HFC interface or over an out-of-band (OOB) wireless or a wireline network. Thus, though the network controller (130) is shown in line with the HFC network (102) and the DAS (104), the controller (130) may be a component separate from the HFC network (102) and the DAS (104).

In some embodiments, the network controller (130) is defined by software algorithms and/or software components which can be implemented virtually (for example, in a field programmable gate array (FPGA)). In other embodiments, the network controller (130) can be implemented in hardware (for example, by a custom-designed chip) positioned within the system (100) or remote to the system (100).

The system (100) also optionally includes the network processor (132). The network processor (132) can receive the sensor data from the sensors (124) and can process the sensor data to yield RF data, network data, network coverage, network deficiency, etc. In such embodiments, the processed sensor data can be transmitted to the network controller (130). For example, the network processor (132) may process the sensor data to determine a network deficiency. In such examples, the network processor (132) may transmit the network deficiency to the network controller (130) and may not transmit all of the sensor data to the network controller (130). Thus, processing the sensor data may be performed by the network processor (132) instead of the network controller (130).

In some embodiments, the network processor (132) may include multiple network processors (132) and the sensor data can be processed at multiple network processors (132). For example, a first network processor (132) may be located near the sensors (124) and may initially process sensor data received from the sensors (124). In the same example, a second network processor (132) may be located near the network controller (130) and may receive the initially processed sensor data and may further process the sensor data prior to transmission to the network controller (130).

The system (100) can include more or less components than shown and described. For example, the system (100) may not include the network processor (132) or the HFC network (102). In other examples, the system (100) may include a different telecommunications network other than the HFC network (102).

FIG. 2A is a dataflow (200A) of the communication network system (100) according to at least one embodiment of the present disclosure. The dataflow (200A) illustrates a portion of the system (100) without the network processor (132).

Though not shown, the dataflow (200A) can begin with initializing the system (100) and determining a number of antennas (118) in the system (100). Determining the number of antennas (118) can include receiving or retrieving antenna (118) device identification as provided by a key installed on the antenna (118) prior to deployment in the system (100).

As shown, the dataflow (200A) also includes receiving sensor data (202A) by the network controller (130) from the sensors (124). As previously described, the sensor data (202A) can include, for example, location(s) of the antenna(s) (118), location(s) of the HFC node(s) (108), RF signal data, spectrum data, and/or a current RF environment. The sensor data (202A) can also be stored or logged in the database (128) for later processing and/or analysis.

The dataflow (200A) also includes the network controller (130) determining RF coverage and/or network deficiencies (204A) in the system (100) based on the sensor data (202A). The RF coverage can be used to determine, for example, network coverage, network performance, network deficiences, etc. The network coverage and/or network performance can include, for example, available bands, transmit power vs. coverage area, a number of devices connected, cellular beam data and/or beamwidth and direction, and/or frequency in use. The RF coverage, network coverage, and/or network performance data can be geographic, frequency, and/or time-based data.

The network deficiencies can include, for example, self-interference in the system, which can be caused by a leak in the HFC network (102) or a defective DAS element (116). Such interference can be determined based on, for example, a frequency and/or spatial interference in time. In the same examples, the RF signal can enter the antenna (118) and be locally identified and filtered. Alternatively, the RF signal can be converted and detected by other sensors in the HFC network (102).

The network controller (130) also receives protocol data (206A) (or other type of data such as, for example, telemetry data) from the spectral management service (126). As previously described, the protocol data (206A) includes, among other data, one or more rules for transmitting data in the system (100) and can be, for example, wireless coexistence protocol data, wireless communication protocol data, long range (LoRa) protocol data, Internet of Things (IoT) protocol data, lower powered device protocol data, over-the-air protocol data, PHY layer protocol data, etc. Further, the network controller (130) can beneficially connect with various databases and devices to obtain necessary protocol data and data from devices corresponding to the protocol data depending on which protocol(s) are being implemented for the system (100).

For example, in embodiments where the system (100) includes the HFC network (102) and the DAS (104), the protocol data can include multiple converged PHY protocols on the HFC network (102) and can also include application programming interfaces (APIs). APIs are a set of rules and protocols that enable different software applications to communicate and exchange data over, for example, the HFC network (102) and the DAS (104). In such examples, the algorithm implemented by the network controller (130) provides endpoints for the APIs such that external protocol data sources can connect to the network controller (130) and provide telemetry such as the sensor data (202A) from the sensors (124) (or other sensors throughout the system (100)). Thus, such network controller (130) and converged PHY protocols beneficially enable implementation of a controlled, regulation compliant, and dense DAS (104) to leverage the HFC network (102) as an intermediate transmit medium and have control over the spectrum and coverage of the DAS (104) as it leverages the HFC network (102).

In other examples, the algorithm as implemented by the network controller (130) can beneficially connect to other protocol data such as, for example, a managed Data Over Cable Service Interface Specification (DOCSIS) core, which can provide information on frequency availability outside of DOCSIS on the HFC network (102). In another example, the algorithm can connect to a 5G core and the corresponding protocol data to enable use of 5G over the HFC network (102) and the DAS (104).

Continuing the dataflow (200A), the network controller (130) uses the protocol data (206A) and the RF coverage and/or network deficiencies (204A) to generate optimized antenna parameters (208A). More specifically, the network controller (130) optimizes the antenna parameters (208) so as to prevent, reduce, or eliminate the network deficiencies (204A) and as constrained by the protocol data (206A) and/or network coverage. For example, the antenna parameters (208) may be optimized to prevent, reduce, or eliminate the network deficiency (204A) within a licensed spectrum band as required by the protocol data (206A). The optimized antenna parameters (208A) can include, for example, a target input frequency, a target output frequency, a start time, a stop time, a duration, a next target frequency, an output power, beam angle(s), a gain, a bandwidth, a schedule frequency change, and/or effective isotropic radiated power (EIRP) settings. It will be appreciated that the optimized antenna parameters (208A) can include other parameters based on different applications and/or implementations.

The dataflow (200A) also includes applying the optimized antenna parameters (208A) to the RF front end (120). The optimized antenna parameters (208A) may be received and applied by the controller (134) to the RF front end (120).

The dataflow (200A) can then repeat, and updated sensor data (202A) from the sensors (124) with the optimized antenna parameters (208A) applied to the RF front end (120) can be received by the network controller (130) for further optimization of the antenna parameters. The dataflow (200A) can end when, for example, the network controller (130) ends the dataflow (200A) or the system (100) is deactivated.

FIG. 2B is a dataflow (200B) of the communication network system (100) according to at least one embodiment of the present disclosure. The dataflow (200B) illustrates a portion of the system (100) with the network processor (132). Generally, the dataflow (200B) is the same as the dataflow (200A) except that the RF coverage and network deficiency (204B) are determined by the network processor (132). The RF coverage and network deficiency (204B) are then received by the network controller (130) from the network processor (132), and the remaining portion of the dataflow (200B) is the same as or similar to the dataflow (200A).

As previously described, though not shown, the network processor (132) can include more than one processor. For example, a first processor (132) can receive sensor data (202B) from the sensors (124) and process the sensor data (202B) to determine RF coverage. The RF coverage can then be processed by a second processor (132), which can further process the RF coverage to determine one or more network deficiencies. In other embodiments, the sensor data (202B) can be processed multiple times for any reason.

Turning to FIG. 3A, a flowchart of a method (300A) according to at least one embodiment of the present disclosure is shown. The method (300A) is used to optimize one or more antenna parameters. The method (300A) can be executed using, for example, a communication network system such as the communication network system (100). It will be appreciated that in some embodiments, the method (300A) can be stored in a cloud architecture (whether native or remote) and implemented virtually.

Step 302A of the method (300A) provides for initializing a communication network system. The communication network system may be the same as or similar to the communication network system (100). The system can self-initialize, or a command for the system to initialize may be generated and sent to the system by, for example, a controller or a user initiating the system.

As previously described, the system can include an HFC network such as the HFC network (102) and a DAS such as the DAS (104). The DAS includes one or more DAS elements such as the DAS elements (116) and each DAS element includes at least an antenna such as the antenna (118), an RF front end such as the RF front end (120), an RF transceiver such as the RF transceiver (122) and a controller such as the controller (134).

Step 304A of the method (300A) provides for detecting one or more antennas in the communication network system. The antennas may be detected by, for example, a network controller such as the network controller (130). The antennas can be detected during the initialization of the system and device identification of each antenna can be received or retrieved by a network controller such as the network controller (130).

In some embodiments, the steps 302A and/or 304A may be optional.

Step 306A of the method (300A) provides for executing a feedback loop. The feedback loop is executed by the network controller and can begin at the same time as when the system is initialized or can be started at a time period after the system is initialized.

Step 308A of the method (300A) provides for receiving sensor data from sensor(s). In other embodiments, the sensor data can be received from a database such as the database (128) and post processed or processed sensor data (processed by, for example, a separate processor) can be received from the database. The sensors may be the same as or similar to the sensors (124) and the sensor data may be the same as or similar to the sensor data (202A), (202B). The sensor data is received by the network controller.

Step 310A of the method (300A) provides for storing the sensor data in a database. The database may be the same as or similar to the database (128) and may store the sensor data as data logs with geographical and/or time data. In some embodiments, the step 310A may be optional.

Step 312A of the method (300A) provides for determining a RF coverage. The RF coverage may be the same as or similar to the RF coverage and network deficiency (204A), (204B) and may be determined by the network controller based on the sensor data.

Step 314A of the method (300A) provides for detecting a network deficiency. The network deficiency may be the same as or similar to the RFcoverage and network deficiency (204A), (204B) and may be determined by the network controller based on the RF coverage and/or sensor data.

In some embodiments, the step 314A is optional. For example, the system (100) may not be experiencing a deficiency, but it MAY still desirable to optimize the antenna parameters to prevent occurrence of the deficiency.

Step 316A of the method (300A) provides for receiving protocol data. The protocol data may be the same as or similar to the protocol data (206A), (206B) and may be received by the network controller from a spectral management service such as the spectral management service (126).

Step 318A of the method (300A) provides for optimizing one or more antenna parameters. The one or more antenna parameters may be optimized by the network controller to prevent, reduce, or minimize the network deficiencies and based on the protocol data and/or RF coverage. In some embodiments, the network controller includes a PHY coexistence management layer that is configured to optimize the one or more antenna parameters using a feedback loop. Such feedback loop can include the steps of, for example, defining or receiving a set point, collecting and/or using data, optimizing the data, and returning to the set point. In such feedback loop, steady state post optimization is achieved for the current set point before optimizing a next set point.

Step 320A of the method (300A) provides for applying the one or more antenna parameters to corresponding antennas. More specifically, the one or more antenna parameters are applied to the RF front ends of one or more DAS elements by, for example, the controller. In some embodiments, the one or more antenna parameters can be transmitted as a JavaScript® Object Notation (JSON) payload, though in other embodiments the one or more antenna parameters can be transmitted in any type of format and/or as structured data, unstructured data, or semi-structured data.

The feedback loop (i.e., steps 308A, 310A, 312A, 314A, 316A, 318A, 310A) is repeated until the network controller ends the feedback loop, the system is deactivated, or user input commands the feedback loop to end. The feedback loop may repeat based on a time interval or an event-based trigger. For example, the feedback loop may repeat every five minutes or when the network controller, a processor, or other system component detects a network deficiency. The event-based trigger can also include other autonomous criteria such as, for example, Proactive Network Maintenance (PNM) algorithms, scheduler triggers, utilization triggers, subscriber service tier triggers, etc.

The method (300A) described in FIG. 3A can include more or less steps. One or more steps or any combination of steps may also be repeated in the method described in FIG. 3A.

Turning to FIG. 3B, a flowchart of a method (300B) according to at least one embodiment of the present disclosure is shown. The method (300B) is used to optimize one or more antenna parameters. The method (300B) can be executed using, for example, a communication network system such as the communication network system (100). It will be appreciated that in some embodiments, the method (300B) can be stored in a cloud architecture (whether native or remote) and implemented virtually.

Step 302B of the method (300B) provides for initializing a communication network system. The step 302B is the same as or similar to the step 302A of the method (300A) described above.

Step 304B of the method (300B) provides for detecting one or more antennas in the communication network system. The step 304B is the same as or similar to the step 304A of the method (300A) described above.

Step 306B of the method (300B) provides for receiving sensor data from sensors. The step 306B is the same as or similar to the step 308A of the method (300A) described above except that the sensor data is received by a network processor such as the network processor (132).

Step 308B of the method (300B) provides for storing the sensor data in a database. The step 308B is the same as or similar to the step 310A of the method (300A) described above.

Step 310B of the method (300B) provides for determining an RF coverage. The step 310B is the same as or similar to the step 312A of the method (300A) described above except that the network processor processes the sensor data and determines the RF coverage.

Step 312B of the method (300B) provides for detecting a network deficiency. The step 312B is the same as or similar to the step 314A of the method (300A) described above except that the network processor determines the network deficiency.

Step 314B of the method (300B) provides for executing a feedback loop. The step 314B is the same as or similar to the step 306A of the method (300A) described above.

Step 316B of the method (300B) provides for receiving the network deficiency. The network deficiency is received by the network controller from the network processor.

Step 318B of the method (300B) provides for receiving protocol data. The step 318B is the same as or similar to the step 316A of the method (300A) described above.

Step 320B of the method (300B) provides for optimizing one or more antenna parameters. The step 320B is the same as or similar to the step 318A of the method (300A) described above.

Step 322B of the method (300B) provides for applying the one or more optimized antenna parameters to corresponding antennas. The step 322B is the same as or similar to the step 320A of the method (300A) described above.

The feedback loop (i.e., steps 316B, 318B, 310B, 322B) is repeated until the network controller ends the feedback loop, the system is deactivated, or user input commands the feedback loop to end. The feedback loop may repeat based on a time interval or an event-based trigger. For example, the feedback loop may repeat every five minutes or when the network controller, a processor, or other system component detects a network deficiency. The event-based trigger can also include other autonomous criteria such as, for example, Proactive Network Maintenance (PNM) algorithms, scheduler triggers, utilization triggers, subscriber service tier triggers, etc.

The method (300B) described in FIG. 3B can include more or less steps. One or more steps or any combination of steps may also be repeated in the method described in FIG. 3B.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

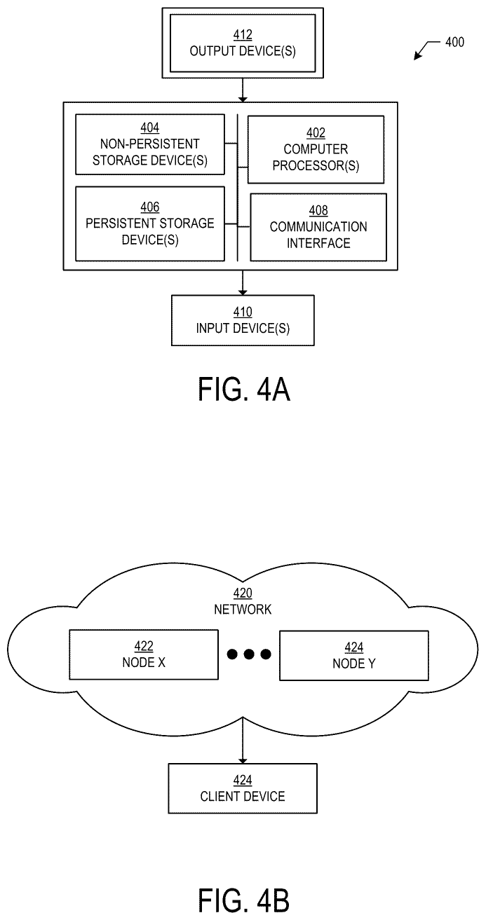

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN) such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (424). The services may include receiving requests and transmitting responses to the client device (424). For example, the nodes may be part of a cloud computing system. The client device (424) may be a computing system, such as the computing system shown in FIG. 4A. Further, the client device (424) may include or perform all or a portion of one or more embodiments.

The computing system of FIG. 4A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for optimizing one or more antenna parameters, the method comprising:
detecting, by a network controller, one or more antennas in a communication network system, each antenna having one or more sensors configured to measure sensor data;
executing, by the network controller, a feedback loop comprising:
receiving the sensor data from the one or more sensors;
determining a radio frequency (RF) coverage based on the sensor data;
receiving protocol data from a spectral management service, the protocol data comprising one or more rules for transmitting data in the communication network system;
optimizing the one or more antenna parameters based on the protocol data and the RF coverage to yield one or more optimized antenna parameters;
applying the one or more optimized antenna parameters to the one or more antennas; and
receiving updated network data from the one or more sensors,
wherein the feedback loop repeats until the network controller commands the feedback loop to end.

2. The method of claim 1, wherein the RF coverage comprises at least one of a network coverage or a network performance.

3. The method of claim 1, further comprising:
detecting a network deficiency based on the sensor data, wherein the one or more antenna parameters are further optimized to at least one of reduce or eliminate the network deficiency.

4. The method of claim 1, wherein the protocol data comprises at least one of wireless coexistence protocol data, non-wireless protocols, wireless communication protocol data, Internet of Things (IoT) protocol data, lower powered device protocol data, or over-the-air protocol data.

5. The method of claim 1, wherein the protocol data is implemented by at least one of an RF physical (PHY) layer or over a hybrid-fiber coaxial (HFC) network using RF.

6. The method of claim 1, further comprising:
initializing the communication network system prior to detecting the one or more antennas.

7. The method of claim 1, further comprising:
storing sensor data, by the sensors, in a database.

8. The method of claim 1, wherein the feedback loop is repeated based on at least one of a time interval or an event-based trigger.

9. The method of claim 8, wherein the event-based trigger comprises at least one of detecting the network deficiency, a scheduled trigger, a utilization trigger, or a maintenance trigger.

10. The method of claim 1, wherein the one or more antenna parameters are optimized by a feedback loop executed by a PHY coexistence management layer.

11. The method of claim 1, wherein the one or more antenna parameters comprises at least one of an antenna frequency, an antenna pattern, an antenna frequency, an antenna pattern, a gain, a bandwidth, a schedule frequency change, or an effective isotropic radiated power (EIRP) setting.

12. The method of claim 1, wherein the one or more antenna parameters are applied to a radio frequency (RF) front end of a distributed antenna system (DAS) element, and wherein the DAS element also includes a corresponding antenna of the one or more antennas.

13. The method of claim 1, wherein the communication network system comprises a hybrid fiber-coaxial (HFC) network comprising an HFC front end in communication with one or more HFC nodes, wherein each HFC node is in communication with one or more end users.

14. The method of claim 12, wherein the network data comprises at least one of a location of each antenna of the one or more antennas, a location of each HFC node of the one or more HFC nodes, and a current RF environment.

15. A method for optimizing one or more antenna parameters, the method comprising:
detecting, by a network controller, one or more antennas in a communication network system, each antenna having one or more sensors configured to measure network data;
receiving, by a network processor, the network data from the one or more sensors;
determining, by the network processor, a network coverage based on the network data;
detecting, by the network processor, a network deficiency based on the network data;
executing, by the network controller, a feedback loop comprising:
receiving the network deficiency from the network processor;
receiving protocol data from a spectral management service, the protocol data comprising one or more rules for transmitting data in the communication network system;
optimizing one or more antenna parameters to reduce the network deficiency based on the protocol data to yield one or more optimized antenna parameters;
applying the one or more optimized antenna parameters to the one or more antennas; and
receiving updated network data from the one or more sensors,
wherein the feedback loop repeats until the network controller commands the feedback loop to end.

16. The method of claim 15, further comprising:
storing, by the network controller, the network data in a database.

17. The method of claim 13, wherein the one or more antenna parameters are optimized by a feedback loop executed by a PHY coexistence management layer.

18. The method of claim 13, wherein the one or more antenna parameters comprises at least one of an antenna frequency, an antenna pattern, an antenna frequency, an antenna pattern, a gain, a bandwidth, a schedule frequency change, or an effective isotropic radiated power (EIRP) setting.

19. The method of claim 13, wherein the one or more antenna parameters are applied to a radio frequency (RF) front end of a distributed antenna system (DAS) element, and wherein the DAS element also includes a corresponding antenna of the one or more antennas.

20. A communication network system comprising:
one or more distributed antenna system (DAS) elements, each DAS element comprising:
an antenna, each antenna having one or more sensors configured to measure network data;
a radio frequency (RF) front end; and
a controller configured to receive and execute one or more optimized antenna parameters;
a spectral management service configured to store protocol data comprising one or more rules for transmitting data in the communication network system;
a network controller in communication with the one or more DAS elements and the spectral management service, the network controller configured to execute a feedback loop comprising:
receiving the network data from the one or more sensors;
determining a network coverage based on the network data;
receiving the protocol data from the spectral management service;
optimizing one or more antenna parameters based on the protocol data and the network coverage to yield the one or more optimized antenna parameters;
applying the one or more optimized antenna parameters to the RF front end of each DAS element; and
receiving updated network data from the one or more sensors,
wherein the feedback loop repeats until the network controller commands the feedback loop to end.
